(19) United States
(12) Patent Application Publication
(10) Pub. No.: US 2012/0262534 A1
(43) Pub. Date: Oct. 18, 2012

(54) VIDEO IMAGE INFORMATION PROCESSING APPARATUS AND VIDEO IMAGE INFORMATION PROCESSING METHOD

(75) Inventor: Mahoro Anabuki, Yokohama-shi (JP)

(73) Assignee: CANON KABUSHIKI KAISHA, Tokyo (JP)

(21) Appl. No.: 13/515,222

(22) PCT Filed: Dec. 7, 2010
(86) PCT No.: PCT/JP2010/007104

§ 371 Date: Jun. 11, 2012

(30) Foreign Application Priority Data
Dec. 17, 2009 (JP) 2009-286892

(51) Int. Cl. H04N 7/14

(52) U.S. Cl. 348/14.07; 348/E07.077

(57) ABSTRACT

A person hesitates to communicate with other person since the person do not know schedule of the other person, and accordingly, opportunities of daily communication are missed, which is a problem. First and second situations of first and second real spaces are recognized based on first and second video images obtained by capturing the first and second real spaces where first and second users 1 and 2 exists, respectively, in advance. A determination as to whether the first and second users 1 and 2 perform display operations of the first and second situations in a bidirectional manner is made based on the first and second situations. First and second display video images to be displayed for the first and second users 1 and 2, respectively, are generated in accordance with a result of the determination in the bidirectional determination step and the second and first video images, respectively.

### TECHNICAL FIELD

The present invention relates to apparatuses and methods for selecting appropriate communication channels depending on situations of two persons to perform remote communications with each other.

### BACKGROUND ART

In general, frequencies of dairy communications among family members have been reduced due to recent trend toward nuclear families and job transfers without being accompanied by families. Since family members do not prefer to disturb other members, they miss opportunities of communications, and therefore, it is difficult to recognize schedules of the family members.

Patent Literature 1 discloses a technique of starting a communication between two persons when one recognizes a presence of the other. However, there arises a problem in that use of this technique allows other persons to know private life which is not desired to be known.

Patent Literature 2 discloses a technique of switching to a communication task such as an answering machine when a phone call is received by a cellular phone in a car or a hospital. In this technique, it is difficult to determine the timing when a person to talk can start communication. Therefore, this technique is not sufficient for taking an opportunity of communication.

### CITATION LIST

### Patent Literature

PTL 1: Japanese Patent Laid-Open No. 2002-314963

PTL 2: Japanese Patent Laid-Open No. 2001-119749

### SUMMARY OF INVENTION

The present invention provides a technique of efficiently making communication by determining a timing or content of communication while situations of persons in communication are considered for protecting privacies.

### Solution to Problem

A video image information processing apparatus controls a video image transmitted between first and second terminals in a bidirectional manner. The video image information processing apparatus includes a first recognition unit configured to recognize a first situation of a first real space in accordance with a first video image obtained by capturing the first real space including the first terminal in advance by a first image pickup unit, a second recognition unit configured to recognize a second situation of a second real space in accordance with a second video image obtained by capturing the second real space including the second terminal in advance by a second image pickup unit, a bidirectional determination unit configured to determine whether a first display unit included in the first terminal and a second display unit included in the second terminal are allowed to display the second real space and the first real space, respectively, in a bidirectional manner, and a control unit configured to perform control so that the first and second terminals transmit video images to each other in a bidirectional manner when the determination of the bidirectional determination unit is affirmative.

A video image information processing apparatus controls a video image transmitted between first and second terminals in a bidirectional manner. The video image information processing apparatus includes a bidirectional determination unit configured to determine whether a first display unit included in the first terminal and a second display unit included in the second terminal are allowed to display the second real space and the first real space, respectively, in a bidirectional manner in accordance with a first situation of a first real space recognized by a first recognition unit on the basis of a first video image obtained by capturing the first real space including the first terminal in advance by a first image pickup unit and a second situation of a second real space recognized by a second recognition unit on the basis of a second video image obtained by capturing the second real space including the second terminal which is different from the first terminal in advance by a second image pickup unit, and a control unit configured to perform control so that the first and second terminals transmit video images to each other in a bidirectional manner when the determination of the bidirectional determination unit is affirmative.

Use of a video image information processing method controls a video image transmitted between first and second terminals in a bidirectional manner. The video image information processing method includes a first recognition step of recognizing a first situation of a first real space in accordance with a first video image obtained by capturing the first real space including the first terminal in advance by a first image pickup unit, a second recognition step of recognizing a second situation of a second real space in accordance with a second video image obtained by capturing the second real space including the second terminal in advance by a second image pickup unit, a bidirectional determination step of determining whether a first display unit included in the first terminal and a second display unit included in the second terminal are allowed to display the second real space and the first real space, respectively, in a bidirectional manner, and a control step of performing control so that the first and second terminals transmit video images to each other in a bidirectional manner when the determination of the bidirectional determination unit is affirmative.

Use of a video image information processing method controls a video image transmitted between first and second terminals in a bidirectional manner. The video image information processing method includes a bidirectional determination step of determining whether a first display unit included in the first terminal and a second display unit included in the second terminal are allowed to display the second real space and the first real space, respectively, in a bidirectional manner in accordance with a first situation of a first real space recognized by a first recognition unit on the basis of a first video image obtained by capturing the first real space including the first terminal in advance by a first image pickup unit and a second situation of a second real space recognized by a second recognition unit on the basis of a second video image obtained by capturing the second real space including the second terminal which is different from the first terminal in advance by a second image pickup unit, and a control step of performing control so that the first and second terminals transmit video images to each other in a bidirectional manner when the determination of the bidirectional determination unit is affirmative.

Further features of the present invention will be apparent from the following description of exemplary embodiments with reference to the attached drawings.

### BRIEF DESCRIPTION OF DRAWINGS

FIG. 1 is a diagram illustrating a configuration of a video image information processing apparatus according to a first embodiment.

FIG. 2A is a diagram illustrating a first configuration example of a bidirectional determination unit included in the video image information processing apparatus according to the first embodiment.

FIG. 2B is a diagram illustrating a second configuration example of the bidirectional determination unit included in the video image information processing apparatus according to the first embodiment.

FIG. 2C is a diagram illustrating a third configuration example of the bidirectional determination unit included in the video image information processing apparatus according to the first embodiment.

FIG. 3 is a flowchart illustrating a process performed by the video image information processing apparatus according to the first embodiment.

FIG. 4 is a diagram illustrating a configuration of a video image information processing apparatus according to a second embodiment.

FIG. 5 is a flowchart illustrating a process performed by the video image information processing apparatus according to the second embodiment.

FIG. 6 is a diagram illustrating a configuration of a video image information processing apparatus according to a third embodiment.

FIG. 7 is a flowchart illustrating a process performed by the video image information processing apparatus according to the third embodiment.

FIG. 8 is a diagram illustrating a configuration of a computer.

### DESCRIPTION OF EMBODIMENTS

A preferred embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

A video image information processing apparatus according to a first embodiment allows start of communication between two users in different real spaces in accordance with situations recognized in the spaces.

Note that the situations relate to the users (persons) and environments (spaces). Examples of the situations include a result of a determination as to whether a person stays in a certain real space, a result of a determination as to who is the person in the certain real space, and a movement, display, a posture, a motion, and an action of the person. Examples of the situations further include brightness and a temperature of the real space, and a movement of an object.

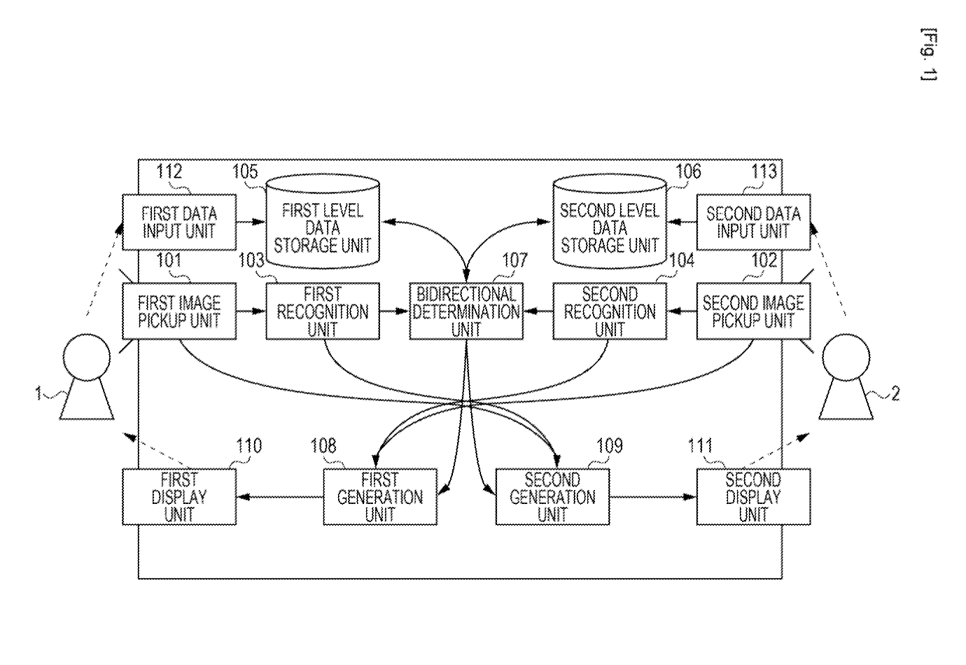

Hereinafter, a configuration and a process of the video image information processing apparatus according to this embodiment will be described with reference to FIG. 1.

FIG. 1 is a diagram schematically illustrating a configuration of a video image information processing apparatus 100 according to the first embodiment.

The video image information processing apparatus 100 includes a first terminal unit 100-1 and a second terminal unit 100-2 which are not shown. The first terminal unit 100-1 includes a first image pickup unit 101 and a first display unit 110. The second terminal unit 100-2 includes a second image pickup unit 102 and a second display unit 111. The video image information processing apparatus 100 further includes a first recognition unit 103, a bidirectional determination unit 107, a first generation unit 108, a second recognition unit 104, and a second generation unit 109. In addition, the video image information processing apparatus 100 includes a first level data storage unit 105, a second level data storage unit 106, a first data input unit 112, and a second data input unit 113.

The first image pickup unit 101 captures a first real space where a first user 1 exists. For example, a living room of a house where the first user 1 lives is captured by a camera. The first image pickup unit 101 may be hung from a ceiling, may be placed on a floor, a table, or a television set, or may be incorporated in a home appliance such as the television set. Furthermore, the first image pickup unit 101 may further include a microphone for recording audio. Moreover, the first image pickup unit 101 may additionally include a human sensitive sensor or a temperature sensor which measures a situation of the real space. A first video image captured by the first image pickup unit 101 is supplied to the first recognition unit 103. Audio, a result of a measurement of the sensor, or the like may be added to the first video image to be output.

The second image pickup unit 102 captures a second real space where a second user 2 exists. For example, a living room of a house where the second user 2 lives is captured by a camera. The second image pickup unit 102 may be the same type as the first image pickup unit 101. A second video image captured by the second image pickup unit 102 is supplied to the second recognition unit 104.

The first recognition unit 103 receives the first video image supplied from the first image pickup unit 101 and recognizes a first situation of the first video image. For example, the first recognition unit 103 recognizes an action (situation) of the first user 1. Specifically, the first recognition unit 103 recognizes actions (situations) including presence of the first user 1, an action of having a meal with the user's family, a situation in which the user came home, an action of watching TV, an action of finishing watching TV, absence of the first user 1, an action of staying still, an action of walking around the room, and an action of sleeping. As a method for realizing recognition of a situation, for example, an action may be recognized by obtaining a position and a motion of a person extracted from a captured video image and an extraction time from a list generated in advance. Furthermore, as a method for realizing recognition of a situation, for example, a result of a measurement performed by a sensor included in a camera may be used. For example, the first recognition unit 103 may be included in a section which includes the first image pickup unit 101 or may be included in a section connected through a network such as a remote server. The first situation recognized by the first recognition unit 103 is supplied to the bidirectional determination unit 107.

The second recognition unit 104 receives a second video image supplied from the second image pickup unit 102 and recognizes a second situation of the second video image. For example, the second recognition unit 104 recognizes an action (situation) of the second user 2. The second recognition unit 104 may be the same type as the first recognition unit 103. The second situation recognized by the second recognition unit 104 is supplied to the bidirectional determination unit 107.

The first level data storage unit 105 stores a first relationship between the first situation to be output from the first recognition unit 103 and a first display level corresponding to the first situation.

Note that the display level means a detail level of a video image to be displayed for notifying the other party of a situation. For example, when a large amount of information such as a captured video image is to be displayed, the detail level is high, that is, the display level is high. When a small amount of information such as a mosaic video image, text display, light blinking, or sound is to be displayed, the detail level is low, that is, the display level is low. Furthermore, a display level in which nothing is displayed may be prepared. Note that ranks of information items to be displayed including a video image, a mosaic video image, text display, light blinking, and sound assigned in accordance with detail levels thereof are used in addition to the display level. Specifically, when a video image having a high detail level is to be displayed, a display level is high whereas when nothing is to be displayed, a display level is low. Note that display levels are assigned to types of video images generated by the first generation unit 108 and the second generation unit 109, which will be described hereinafter.

Here, the relationship means that a situation in which a user simply exists may correspond to a display level for text display, and a situation in which the user is having a meal may correspond to a display level for a video image. Furthermore, a situation in which the user came home may correspond to a level for displaying nothing. Moreover, a condition in which a situation of the first user 1 may be easily displayed for the second user 2 but may not be displayed for a third user may be added to each of the relationships. In addition, situations to be displayed from the first user 1 to another user and situations to be displayed from the other user to the first user 1 may correspond to display levels.

A first relationship between the situations and the display levels is supplied from the first data input unit 112 which will be described below and stored in the first level data storage unit 105. Furthermore, the relationship may be dynamically changed in the course of processing according to the present invention.

The first level data storage unit 105 receives the first situation from the bidirectional determination unit 107 and supplies the display level represented by the first relationship of the first situation to the bidirectional determination unit 107 as a first display level.

The second level data storage unit 106 stores a second relationship between a second situation to be output from the second recognition unit 104 and a second display level corresponding to the second situation. The second level data storage unit 106 may be the same type as the first level data storage unit 105. The second relationship between the situation and the display level is supplied from the second data input unit 113 which will be described below and stored in the second level data storage unit 106. The second level data storage unit 106 receives the second situation from the bidirectional determination unit 107 and supplies the display level represented by the second relationship of the second situation to the bidirectional determination unit 107 as a second display level.

The bidirectional determination unit 107 compares the first and second display levels with each other so as to determine a level of communication to be performed by the first and second user 2.

Specifically, the bidirectional determination unit 107 receives the first situation from the first recognition unit 103 and the second situation from the second recognition unit 104. Furthermore, the bidirectional determination unit 107 supplies the first and second situations to the first and second level data storage unit 105 and 106, respectively, so as to obtain the first and second display levels.

The bidirectional determination unit 107 compares the first and second display levels with each other. When the first and second display levels are equal to each other, it is determined that the first and second display levels correspond to the level of the communication to be performed by the first and second users 1 and 2.

When a detail level of the first display level is higher than a detail level of the second display level, the situation of the first user 1 may be displayed for the second user 2 in a high detail level but the situation of the second user 2 may not be displayed for the first user 1 in a high detail level. On the other hand, when the detail level of the first display level is lower than the detail level of the second display level, the situation of the first user 1 may not be displayed in the high detail level but the situation of the second user 2 may be displayed in the high detail level.

Therefore, when the situations of the first and second users 1 and 2 are to be displayed in the same level, the first and second display levels which can be used for display without problem are determined as a display level which is acceptable by the first and second users 1 and 2. When the detail level of the first display level is lower than the detail level of the second display level, the second display level which corresponds to the highest detail level and which can be used for display without problem is determined as a display level which is acceptable by the first and second users 1 and 2.

For example, when the first display level corresponds to a display level for displaying a video image of a high detail level and the second display level corresponds to a display level for displaying text of a low detail level, it is determined that display is performed in a level for displaying nothing or a level for displaying text in both sides.

Furthermore, when the first and second display levels are different from each other, it may be determined that display is performed in the level for displaying nothing in both sides.

As a result of the determination, the display level for display of the situation of the second user 2 for the first user 1 is supplied to the first generation unit 108. On the other hand, the display level for display of the situation of the first user 1 for the second user 2 is supplied to the second generation unit 109.

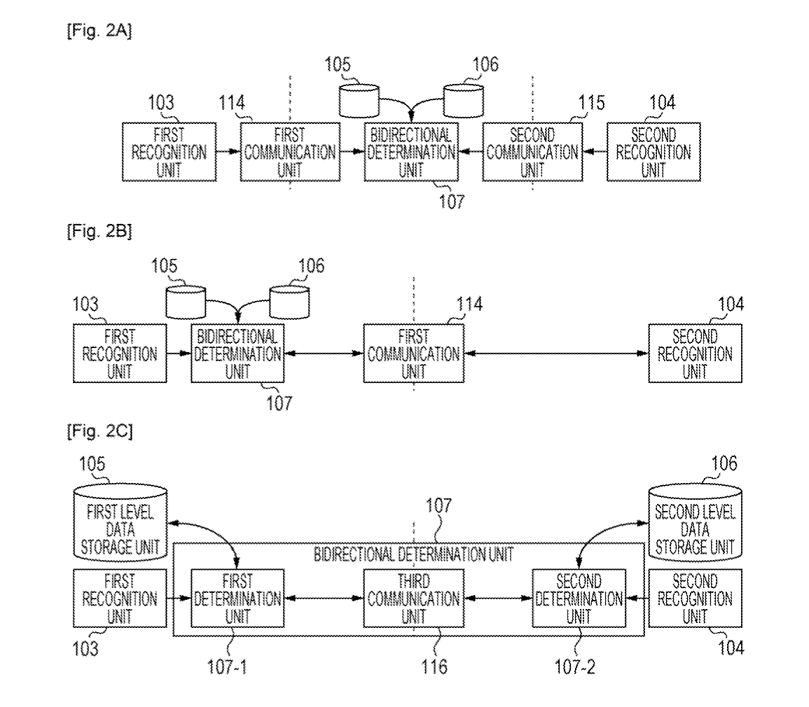

Note that the bidirectional determination unit 107 may be directly connected to the first and second recognition units 103 and 104 as shown in FIG. 1 or may be connected to the first and second recognition units 103 and 104 through a network. Furthermore, the bidirectional determination unit 107 may include two sub-systems therein. FIGS. 2A to 2C show three types of configuration example of the bidirectional determination unit 107.

In FIG. 2A, the bidirectional determination unit 107 is connected to the first recognition unit 103 through a network using a first communication unit 114. The bidirectional determination unit 107 is connected to the second recognition unit 104 through the network using a second communication unit 115. The bidirectional determination unit 107 is realized in an apparatus such as a server installed in a location different from the real spaces where the first and second users 1 and 2 exist. Furthermore, the first and second level data storage units 105 and 106 are similarly installed.

In FIG. 2B, the bidirectional determination unit 107 is directly connected to the first recognition unit 103 and is connected to the second recognition unit 104 through the network using the first communication unit 114. The first and second level data storage units 105 and 106 are realized in apparatuses included in the first real space where the first user 1 exists. The first and second level data storage units 105 and 106 may be included in the second real space where the second user 2 exists.

In FIG. 2C, the bidirectional determination unit 107 includes two sub-systems. That is, the bidirectional determination unit 107 includes first and second determination units 107-1 and 107-2. The first and second determination units 107-1 and 107-2 communicate with each other through a third communication unit 116. Then, a level comparison unit included in the bidirectional determination unit 107 compares the first and second display levels with each other. In this way, a level of communication to be performed is determined. Specifically, the bidirectional determination unit 107 strides over the first and second real spaces where the first and second users 1 and 2 exist, respectively.

Note that, in FIGS. 2A to 2C, the first and second recognition units 103 and 104 connected to the bidirectional determination unit 107 are shown. Furthermore, the first and second level data storage units 105 and 106 are shown. The first and second recognition units 103 and 104 and the first and second level data storage units 105 and 106 may be included in the first and second real spaces where the first and second users 1 and 2 exist, respectively, and may be included in real spaces other than the real spaces where the first and second users 1 and 2 exist.

In addition, the first and second generation units 108 and 109 are not shown in FIG. 2. A connection example where the bidirectional determination unit 107 is included in a real space other than the first and second real spaces where the first and second users I and 2 exist, respectively, and the first and second generation units 108 and 109 are included will be described. The bidirectional determination unit 107 is connected to the first and second generation units 108 and 109 through communication units.

The first generation unit 108 generates a first display video image to be displayed for the first user 1. The generation is performed in accordance with the second display level supplied from the bidirectional determination unit 107. Furthermore, when the first display video image is generated, the second video image captured by the second image pickup unit 102 and the second situation are used.

For example, when the display level represents display of a video image, the second video image serves as the first display video image without change. When the second situation represents that the user is having a meal, a video image synthesized with text “having a meal” representing the situation serves as a first display video image.

For example, the display level represents text display, a first display video image including the text “having a meal” representing the second situation and text representing a time when the user starts having a meal is generated.

The display level represents light blinking, for example, a color representing sleeping, having a meal, or staying out can be lit in accordance with the second situation.

When the display level represents sound, for example, a first display video image including text “only sound” is generated.

The generated first display video image is supplied to the first display unit 110.

The second generation unit 109 generates a second display video image to be displayed for the second user 2. The generation is performed in accordance with the first display level supplied from the bidirectional determination unit 107. Furthermore, when the second display video image is generated, the first video image captured by the first image pickup unit 101 and the first situation are used. The second generation unit 109 may be the same type as the first generation unit 108. The generated second display video image is supplied to the second display unit 111.

The first display unit 110 displays the first display video image obtained from the first generation unit 108 in the first real space. The video image information processing apparatus 100 includes a plurality of communication channels such as a display device and a speaker, for example, and displays the first display video image by means of the display device or a projector. For example, text is displayed by means of an electric bulletin board.

The second display unit 111 displays the second display video image obtained from the second generation unit 109 in the second real space. The second display unit 111 may be the same type as the first display unit 110.

The first data input unit 112 is used to input the first relationship between the first situation output from the first recognition unit 103 and the first display level corresponding to the first situation. The first data input unit 112 includes a mouse and a keyboard, for example. Using the first data input unit 112, relationships can be added, edited, and deleted.

The second data input unit 113 is used to input the second relationship between the second situation output from the second recognition unit 104 and the second display level corresponding to the second situation.

The configuration of the video image information processing. apparatus 100 according to this embodiment has been described hereinabove.

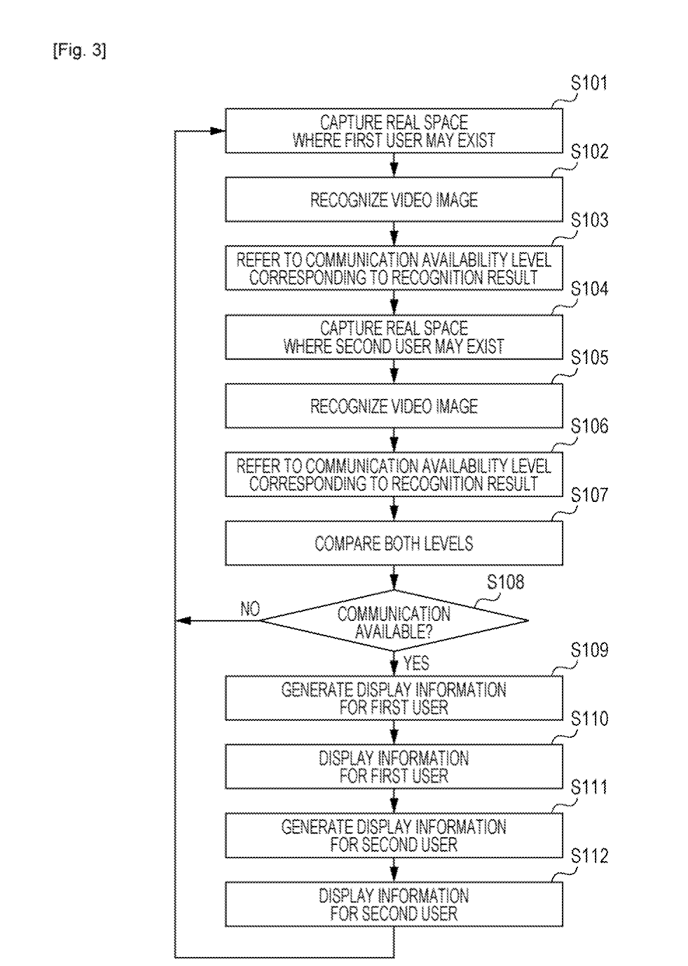

A process performed by the video image information processing apparatus 100 of this embodiment will be described with reference to a flowchart shown in FIG. 3.

In step S101, the first image pickup unit 101 captures the first real space where the first user 1 exists. Here, audio in the first real space may be recorded. A first video image captured by the first image pickup unit 101 is supplied to the first recognition unit 103, and the process proceeds to step S102.

In step S102, the first recognition unit 103 receives the first video image from the first image pickup unit 101 and recognizes a first situation of the first video image. The first situation recognized by the first recognition unit 103 is supplied to the bidirectional determination unit 107, and the process proceeds to step S103.

In step S103, the bidirectional determination unit 107 receives the first situation from the first recognition unit 103. Then, the bidirectional determination unit 107 supplies the first situation to the first level data storage unit 105 so as to obtain a first display level, and the process proceeds to step S104. Note that the first level data storage unit 105 stores a first relationship between the first situation output from the first recognition unit 103 and the first display level corresponding to the first situation. Furthermore, the first relationship between the first situation output from the first recognition unit 103 and the first display level corresponding to the first situation has been input by the first data input unit 112.

In step S104, the second image pickup unit 102 captures the second real space where the second user 2 exists. Here, audio in the second real space may be recorded. A second video image captured by the second image pickup unit 102 is supplied to the second recognition unit 104, and the process proceeds to step S105.

In step S105, the second recognition unit 104 receives the second video image supplied from the second image pickup unit 102 so as to recognize a second situation of the second video image. The second situation recognized by the second recognition unit 104 is supplied to the bidirectional determination unit 107, and the process proceeds to step S106.

In step S106, the bidirectional determination unit 107 receives the second situation from the second recognition unit 104. Then, the bidirectional determination unit 107 supplies the second situation to the second level data storage unit 106 so as to obtain a second display level, and the process proceeds to step S107. Note that the second level data storage unit 106 stores a second relationship between the second situation output from the second recognition unit 104 and the second display level corresponding to the second situation. Furthermore, the second relationship between the second situation output from the second recognition unit 104 and the second display level corresponding to the second situation has been input by the second data input unit 113.

Subsequently, the process proceeds to step S107.

Note that although the process sequentially proceeds from step S101 to step S106 in the above description, the process may proceed in a different order. That is, as long as step S101 is performed before step S102 and step S102 is performed before step S103, these three steps may not be consecutively performed. As long as step S104 is performed before step S105 and step S105 is performed before step S106, these three steps may not be consecutively performed. For example, step S104 may be inserted after step S101, or step S104, step S105, and step S106 may be performed before step S101, step S102, and step S103 are performed.

In step S107, the bidirectional determination unit 107 compares the first and second display levels with each other so as to determine a level of communication to be performed between the first and second users 1 and 2. As a result of the determination, a display level of the second user 2 for display for the first user 1 is supplied to the first generation unit 108. On the other hand, a display level of the first user 1 for display for the second user 2 is supplied to the second generation unit 109.

In step S108, the bidirectional determination unit 107 determines whether a level of communication performed between the first and second communication has been obtained. When the determination is negative, the process returns to step S101. On the other hand, when the determination is affirmative, the process proceeds to step S109.

In step S109, the first generation unit 108 generates a first display video image to be displayed for the first user 1. The generated first display video image is controlled as a video image which is allowed to be displayed and is output to the first display unit 110. Thereafter, the process proceeds to step S110.

In step S110, the first display unit 110 displays the first display video image obtained from the first generation unit 108 in the first real space, and the process proceeds to step S111.

In step S111, the second generation unit 109 generates a second display video image to be displayed for the second user 2. The generated second display video image is controlled as a video image which is allowed to be displayed and is output to the second display unit 111. Thereafter, the process proceeds to step S112.

In step S112, the second display unit 111 displays the second display video image obtained from the second generation unit 109 in the second real space, and the process returns to step S101.

Note that although the process sequentially proceeds from step S109 to step S112 in the description described above, the process may proceed in a different order. That is, as long as step S109 is performed before step S110, these two steps may not be consecutively performed. Furthermore, as long as step S111 is performed before step S112, these two steps may not be consecutively performed. For example, step S111 may be inserted after step S109. Step S111 and step S112 may be performed before step S109 and step S110 are performed.

Note that the case where this embodiment is applied to the communication between the two users has been taken as an example. However, even when this embodiment is applied to communication between three or more users, display operations are performed between two of the users.

The video image information processing apparatus 100 normally recognizes the captured video images in the two real spaces by performing the process described above, and display operations are performed in accordance with the situations of the two real spaces. As the situations of the real spaces change, the display levels also change. This process is automatically performed without apparent interaction performed by the users. For example, it is assumed that when the both situations represent that the users are having a meal, receptions of display of the situations including the captured video images are accepted. In this case, when meal times of both sides coincide with each other, both spaces are automatically connected to each other through the displayed video images. By this, the family members who are separately located in two places virtually get together for the meal.

According to this embodiment, two or more users who are located in different places specify conditions of levels of acceptable communication depending on certain situations in advance. When the conditions of both sides coincide with each other, the communication of the levels accepted by both sides is automatically started. In this communication, the users themselves do not have to have motivations for performing the communication. Since a channel of the communication in accordance with the level accepted by the both sides is selected, the communication may be performed without considering convenience of the other party.

### Second Embodiment

In the first embodiment, real-time remote communication is automatically started. On the other hand, in a second embodiment, time-difference remote communication is automatically started.

Hereinafter, a configuration of a video image information processing apparatus of a second embodiment and a process performed by the video image information processing apparatus will be described with reference to the accompanying drawings.

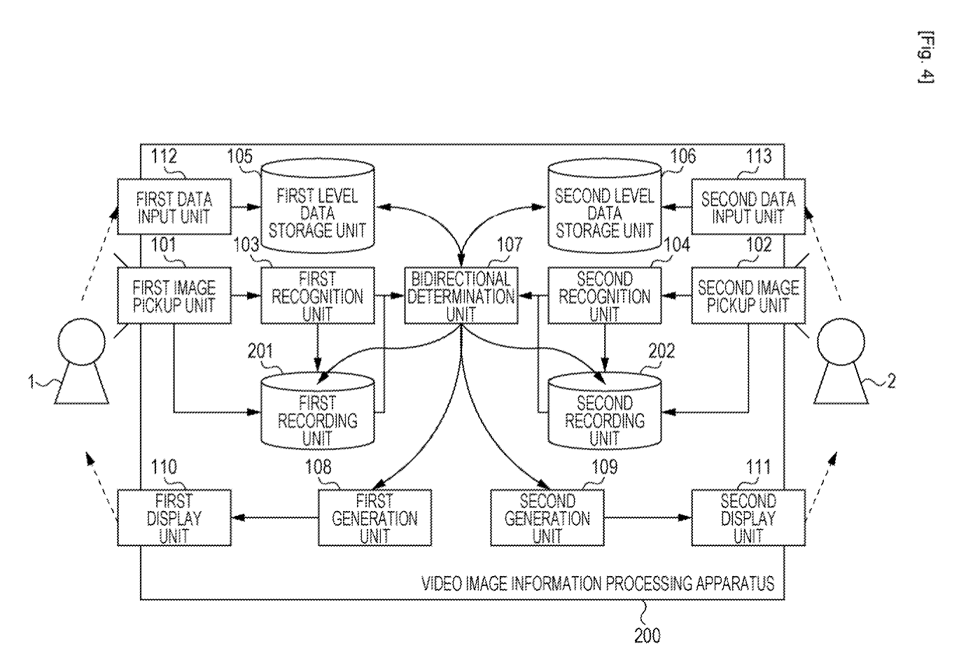

FIG. 4 is a diagram schematically illustrating a configuration of a video image information processing apparatus 200 according to the second embodiment. As shown in FIG. 4, the video image information processing apparatus 200 includes a first image pickup unit 101, a second image pickup unit 102, a first recognition unit 103, and a second recognition unit 104. The video image information processing apparatus 200 further includes a first level data storage unit 105, a second level data storage unit 106, and a bidirectional determination unit 107. The video image information processing apparatus 200 still further includes a second generation unit 109, a second display unit 111, and a first recording unit 201. Moreover, the video image information processing apparatus 200 includes a first generation unit 108, a first display unit 110, and a second recording unit 202. Components the same as those of the video image information processing apparatus 100 have names the same as those of the video image information processing apparatus 100, and detailed descriptions of the overlapping portions are omitted.

The first image pickup unit 101 captures a first real space where a first user 1 exists. A first video image captured by the first image pickup unit 101 is supplied to the first recognition unit 103.

The second image pickup unit 102 captures a second real space where a second user 2 exists. A second video image captured by the second image pickup unit 102 is supplied to the second recognition unit 104.

The first recognition unit 103 receives the first video image supplied from the first image pickup unit 101 and recognizes a first situation of the first video image. The first situation recognized by the first recognition unit 103 is supplied to the bidirectional determination unit 107.

The second recognition unit 104 receives the second video image supplied from the second image pickup unit 102 and recognizes a second situation of the second video image. The second situation recognized by the second recognition unit 104 is supplied to the bidirectional determination unit 107.

The first level data storage unit 105 stores a first relationship between the first situation output from the first recognition unit 103 and a first display level corresponding to the first situation. The first level data storage unit 105 receives the first situation supplied from the bidirectional determination unit 107 and supplies a display level represented by the first relationship corresponding to the first situation to the bidirectional determination unit 107 as a first display level.

The second level data storage unit 106 stores a second relationship between the second situation output from the second recognition unit 104 and a second display level corresponding to the second situation. The second level data storage unit 106 receives the second situation supplied from the bidirectional determination unit 107 and supplies a display level represented by the second relationship corresponding to the second situation to the bidirectional determination unit 107 as a second display level.

The bidirectional determination unit 107 compares the first and second display levels with each other so as to determine a level of communication to be performed by the first and second users 1 and 2. As a result of the determination, a display level of the second user 2 for display for the first user 1 is supplied to the first generation unit 108. On the other hand, a display level of the first user 1 for display for the second user 2 is supplied to the second generation unit 109.

Furthermore, as the result of the determination, when the level of the communication to be performed by the first and second users 1 and 2 corresponds to a level representing that the display is not performed, an instruction for recording the video images and the recognized situations is issued to the first and second recording units 201 and 202. If the level of the communication to be performed by the first and second users 1 and 2 changes to a level representing that the display is available after the recording is started, an instruction for generating display images on the basis of information on the recorded video images is output to the first and second generation units 108 and 109. If the level representing that the display is not performed is not changed for a predetermined period of time, an instruction for deleting the video images and the situations which have been recorded for the predetermined period of time is supplied to the first and second recording units 201 and 202.

The first generation unit 108 generates a first display video image to be displayed for the first user 1. For example, the first display video image may be generated only using a video image captured at a certain time point and a situation at the certain time point. Specifically, a slide show of video images which are captured at a plurality of time points, a digest video image obtained by extracting some of a plurality of video images and connecting the extracted images to one another, or a distribution table of a plurality of situations may be used. The generated first display video image is supplied to the first display unit 110.

The second generation unit 109 generates a second display video image to be displayed for the second user 2. The second generation unit 109 may be the same as the first generation unit 108. The generated second display video image is supplied to the second display unit 111.

The first display unit 110 displays the first display video image obtained from the first generation unit 108 in the first real space.

The second display unit 111 displays the second display video image obtained from the second generation unit 109 in the second real space.

The first data input unit 112 is used to input the first relationship between the first situation output from the first recognition unit 103 and the first display level corresponding to the first situation.

The second data input unit 113 is used to input the second relationship between the second situation output from the second recognition unit 104 and the second display level corresponding to the second situation.

The first recording unit 201 records the first video image supplied from the first image pickup unit 101, the first situation supplied from the first recognition unit 103, and a recording time. The first recording unit 201 corresponds to a data server, for example. When receiving the instruction of deleting data which has been stored for a predetermined period of time from the bidirectional determination unit 107, the first recording unit 201 deletes the data. The recorded first video image, the recorded first situation, and the recorded recording time are supplied to the bidirectional determination unit 107.

The second recording unit 202 records the second video image supplied from the second image pickup unit 102, the second situation supplied from the second recognition unit 104, and a recording time. When receiving the instruction of deleting data which has been stored for a predetermined period of time from the bidirectional determination unit 107, the second recording unit 202 deletes the data. The recorded second video image, the recorded second situation, and the recorded recording time are supplied to the bidirectional determination unit 107.

The configuration of the video image information processing apparatus 200 of this embodiment has been described hereinabove.

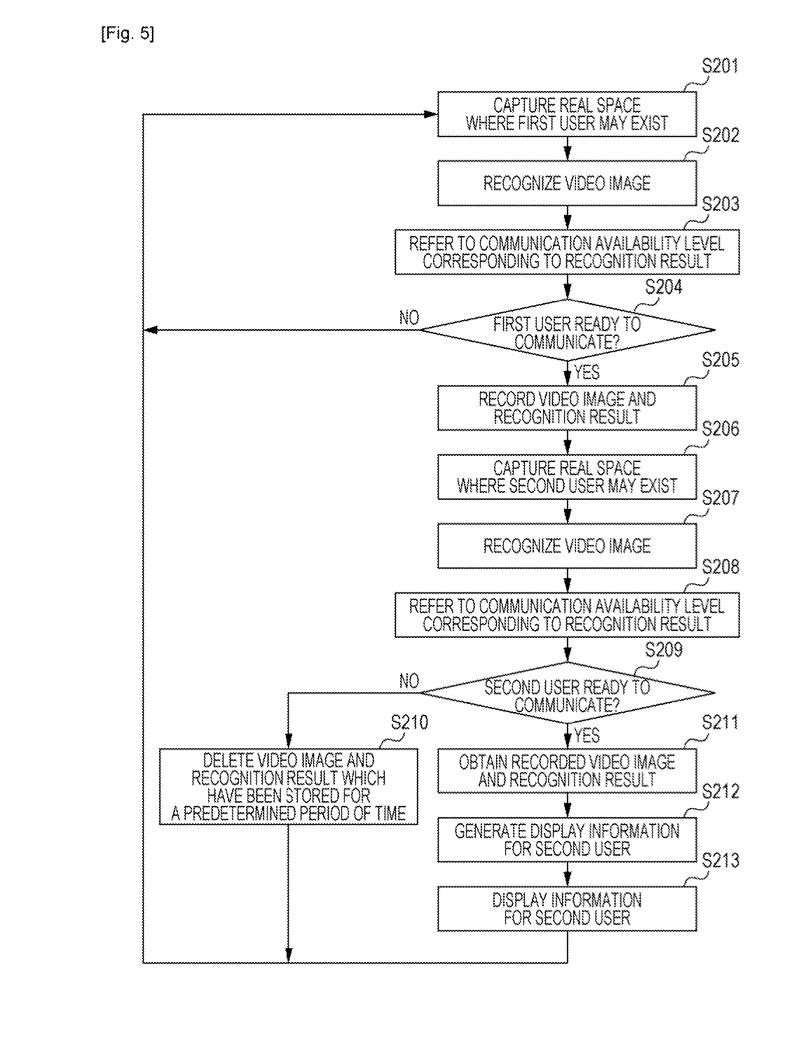

Referring to a flowchart shown in FIG. 5, a process performed by the video image information processing apparatus 200 of this embodiment will be described. Note that program codes to be executed in accordance with the flowchart are stored in a memory such as a RAM (Random Access Memory) or a ROM (Read Only Memory) and are read and executed by the CPU, for example.

In step S201, the first image pickup unit 101 captures the first real space where the first user 1 exists. Here, audio of the first real space may be recorded. A first video image captured by the first image pickup unit 101 is supplied to the first recognition unit 103, and the process proceeds to step S202.

In step S202, the first recognition unit 103 receives the first video image supplied from the first image pickup unit 101 and recognizes a first situation of the first video image. The first situation recognized by the first recognition unit 103 is supplied to the bidirectional determination unit 107, and the process proceeds to step S203.

In step S203, the bidirectional determination unit 107 receives the first situation from the first recognition unit 103. Thereafter, the bidirectional determination unit 107 supplies the first situation to the first level data storage unit 105 so as to obtain a first display level, and the process proceeds to step S204. Note that the first level data storage unit 105 has stored a first relationship between the first situation output from the first recognition unit 103 and the first display level corresponding to the first situation. Furthermore, the first relationship between the first situation output from the first recognition unit 103 and the first display level corresponding to the first situation has been input by the first data input unit 112.

In step S204, the bidirectional determination unit 107 determines whether the obtained first display level corresponds to a level representing that display is allowed to be performed for the second user 2. When the determination is negative in step S204, the process returns to step S201. On the other hand, when the determination is affirmative in step S204, the process proceeds to step S205.

In step S205, the first recording unit 201 records the first video image supplied from the first image pickup unit 101, the first situation supplied from the first recognition unit 103, and a recording time, and the process proceeds to step S206.

In step S206, the second image pickup unit 102 captures the second real space. A second video image captured by the second image pickup unit 102 is supplied to the second recognition unit 104, and the process proceeds to step S207.

In step S207, the second recognition unit 104 receives the second video image supplied from the second image pickup unit 102 and recognizes a second situation of the second video image. The second situation recognized by the second recognition unit 104 is supplied to the bidirectional determination unit 107, and the process proceeds to step S208.

In step S208, the bidirectional determination unit 107 receives the second situation from the second recognition unit 104. Thereafter, the bidirectional determination unit 107 supplies the second situation to the second level data storage unit 106 so as to obtain a second display level, and the process proceeds to step S209. Note that the second level data storage unit 106 has stored a second relationship between the second situation output from the second recognition unit 104 and the second display level corresponding to the second situation. Note that, the second relationship between the second situation output from the second recognition unit 104 and the second display level corresponding to the second situation has been input by the second data input unit 113.

In step S209, the bidirectional determination unit 107 determines whether the obtained second display level corresponds to a level representing that display is allowed to be performed for the first user 1. When the determination is negative in step S209, the process proceeds to step S210. On the other hand, when the determination is affirmative in step S209, the process proceeds to step S211.

In step S210, the bidirectional determination unit 107 supplies an instruction for deleting data which has been stored for a predetermined period of time to the first recording unit 201. When receiving the instruction of deleting data which has been stored for a predetermined period of time from the bidirectional determination unit 107, the first recording unit 201 deletes the data. Thereafter, the process returns to step S201.

In step S211, the bidirectional determination unit 107 obtains the first video image, the first situation, and the recording time which have been stored in the first recording unit 201. The obtained first video image, the obtained first situation, and the obtained recording time are supplied to the second generation unit 109, and the process proceeds to step S212.

In step S212, the second generation unit 109 generates a second display video image to be displayed for the second user 2. The second display video image is controlled as a video image which is allowed to be displayed and is output to the second display unit 111. Thereafter, the process proceeds to step S213.

In step S213, the second display unit 111 displays the second display video image obtained from the second generation unit 109 in the second real space, and the process returns to step S201.

By performing the process described above, the video image information processing apparatus 200 recognizes the video images in the first and second real spaces and performs display in accordance with the first and second situations. Note that when the second user 2 to receive the first video image is not available, the video image information processing apparatus 200 sequentially records situations of the first user 1 serving as a source of display of the video image. When the second user 2 to receive the video image becomes available, the recorded situations are displayed in addition to items relating to the situations. In this way, the second use may collectively recognize the video image of the first user 1 including the previous situations when the second user 2 becomes available:

Note that the display of the situation of the first user 1 for the second user 2 and the display of the situation of the second user 2 for the first user 1 may be performed similarly to each other.

### Third Embodiment

In the first and second embodiments, the bidirectional determination unit 107 obtains the first and second display levels from the first and second situations, respectively. However, in a third embodiment, a determination is performed without obtaining a display level. Specifically, when the first and second situations correspond to specific situations, it is determined that video images are displayed.

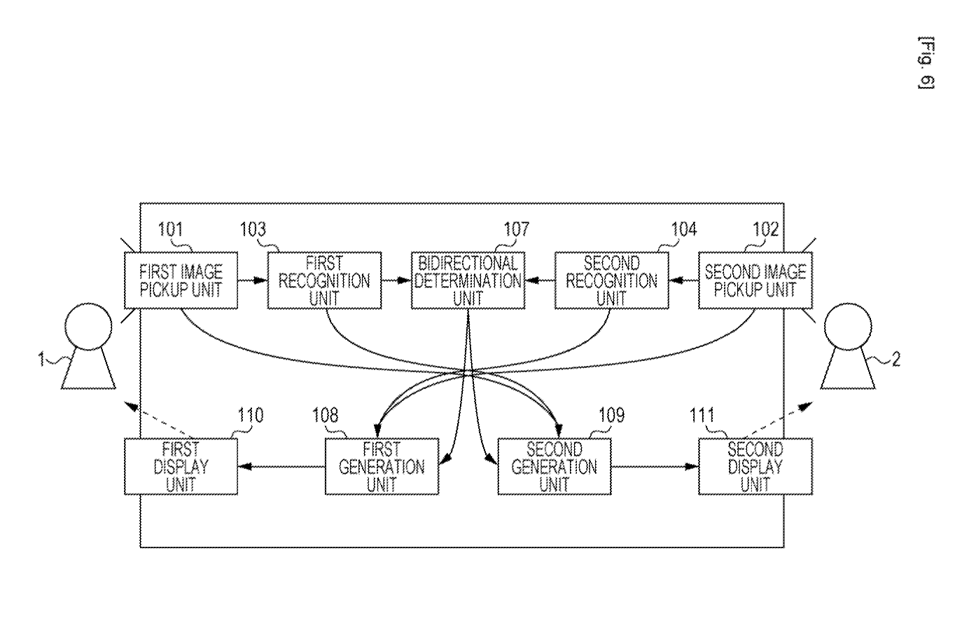

FIG. 6 is a diagram schematically illustrating a video image information processing apparatus 300 of this embodiment. As shown in FIG. 4, the video image information processing apparatus 300 includes a first image pickup unit 101, a second image pickup unit 102, a first recognition unit 103, a second recognition unit 104, and a bidirectional determination unit 107. The video image information processing apparatus 300 further includes a second generation unit 109 and a second display unit 111. The video image information processing apparatus 300 still further includes a first generation unit 108 and a first display unit 110. Components the same as those of the video image information processing apparatus 100 shown in FIG. 1 are denoted by reference numerals the same as those shown in FIG. 1, and therefore, detailed descriptions of the overlapping portions are omitted.

The first image pickup unit 101 captures a first real space where a first user 1 exists. A first video image captured by the first image pickup unit 101 is supplied to the first recognition unit 103.

The second image pickup unit 102 captures a second real space where a second user 2 exists. A second video image captured by the second image pickup unit 102 is supplied to the second recognition unit 104.

The first recognition unit 103 receives the first video image from the first image pickup unit 101 and recognizes a first situation of the first video image. The first situation recognized by the first recognition unit 103 is supplied to the bidirectional determination unit 107.

The second recognition unit 104 receives the second video image from the second image pickup unit 102 and recognizes a second situation of the second video image. The second situation recognized by the second recognition unit 104 is supplied to the bidirectional determination unit 107.

The bidirectional determination unit 107 compares the first and second situations with each other so as to determine whether display operations of the first and second users l and 2 are available. For example, it is determined that the display operations are available only when the first and second users 1 and 2 are having a meal. Specifically, when the first user 1 is having a meal and a second user 2 is similarly having a meal, it is determined that the display operations are available. On the other hand, in a case where the second user 2 is not having a meal although the first user 1 is having a meal, it is determined that the display operations are not available. As a result of the determination, the second video image and the second situation are supplied to the first generation unit 108 whereas the first video image and the first situation are supplied to the second generation unit 109.

The first generation unit 108 generates a first display video image to be displayed for the first user 1. For example, the first display video image may be obtained by synthesizing the second video image with text representing a menu of the meal. The generated first display video image is supplied to the first display unit 110.

The second generation unit 109 generates a second display video image to be displayed for the second user 2. The second generation unit 109 may be the same type as the first generation unit 108. The generated second display video image is supplied to the second display unit 111.

The first display unit 110 displays the first display video image obtained from the first generation unit 108 in the first real space.

The second display unit 111 displays the second display video image obtained from the second generation unit 109 in the second real space.

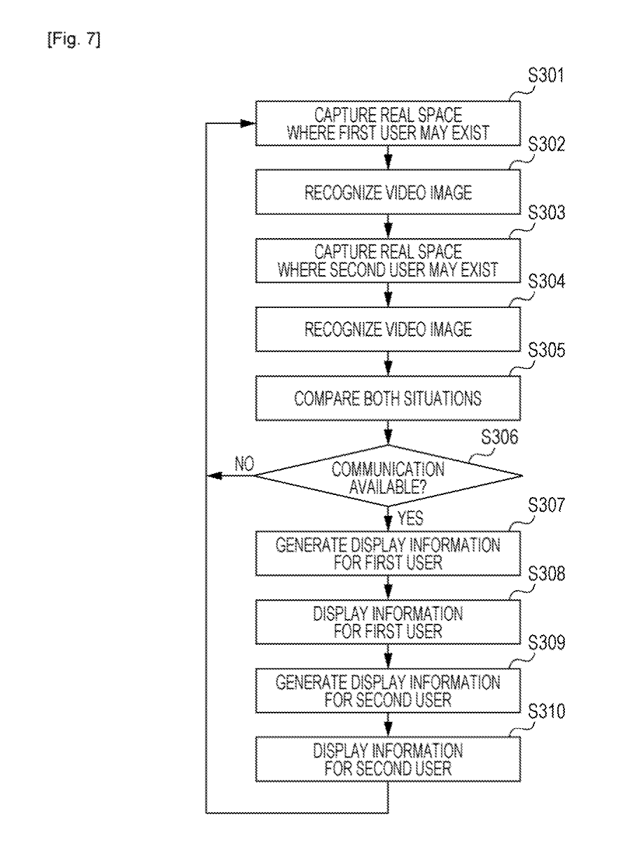

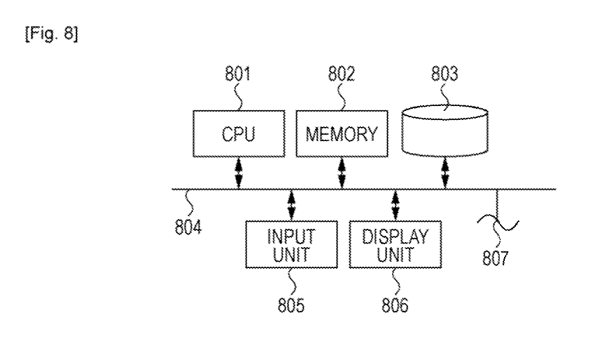

Referring now to a flowchart shown in FIG. 7, a process performed by the video image information processing apparatus 300 will be described.

In step S301, the first image pickup unit 101 captures the first real space where the first user 1 exists. Here, audio in the first real space may be recorded. A first video image captured by the first image pickup unit 101 is supplied to the first recognition unit 103, and the process proceeds to step S302.

In step S302, the first recognition unit 103 receives the first video image from the first image pickup unit 101 and recognizes a first situation of the first video image. The first situation recognized by the first recognition unit 103 is supplied to the bidirectional determination unit 107. Thereafter, the process proceeds to step S103.

In step S303, the second image pickup unit 102 captures the second real space where the second user 2 exists. Here, audio in the second real space may be recorded. A second video image captured by the second image pickup unit 102 is supplied to the second recognition unit 104, and the process proceeds to step S304.

In step S304, the second recognition unit 104 receives the second video image from the second image pickup unit 102 and recognizes a second situation of the second video image. The second situation recognized by the second recognition unit 104 is supplied to the bidirectional determination unit 107. Thereafter, the process proceeds to step S305.

In step S305, the bidirectional determination unit 107 compares the first and second situations with each other so as to determine whether display operations of the first and second users 1 and 2 are available. Then, the process proceeds to step S306.

When the determination is negative in step S306, the process returns to step S301. On the other hand, when the determination is affirmative in step S306, the second video image and the second situation are supplied to the first generation unit 108 whereas the first video image and the first situation are supplied to the second generation unit 109. Thereafter, the process proceeds to step S307.

In step S307, the first generation unit 108 generates a first display video image to be displayed for the first user 1. The generated first display video image is supplied to the first display unit 110, and the process proceeds to step S308:

In step S308, the first display unit 110 displays the first display video image obtained from the first generation unit 108 in the first real space. Then, the process proceeds to step S309.

In step S309, the second generation unit 109 generates a second display video image to be displayed for the second user 2. The generated second display video image is supplied to the second display unit 111. Then, the process proceeds to step S310.

In step S310, the second display unit 111 displays the second display video image obtained from the second generation unit 109 in the second real space. Then, the process returns to step S301.

By performing the process described above, the video image information processing apparatus 300 constantly recognizes the captured video images in the two real spaces and performs the display operations in accordance with the situations. As the situations of the real spaces change from moment to moment, the display operations are automatically started without apparent interaction performed by the users. For example, it is assumed that the both situations represent that the users are having a meal and receptions of display of the situations including the captured video images are accepted. In this case, when meal times of both sides coincide with each other, the both spaces are automatically connected to each other through the displayed video images. By this, the family members who are separately located in two places virtually get together for the meal.

### Other Embodiments

FIG. 6 is a diagram illustrating a configuration of a computer.

Note that the present invention can be applied to an apparatus comprising a single device or to system constituted by a plurality of devices.

Furthermore, the invention can be implemented by supplying a software program. which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-286892 filed Dec. 17, 2009, which is hereby incorporated by reference herein in its entirety.

1. A video image information processing apparatus which controls a video image transmitted between first and second terminals in a bidirectional manner, the video image information processing apparatus comprising:
a first recognition unit configured to recognize a first situation of a first real space in accordance with a first video image obtained by capturing the first real space including the first terminal in advance by a first image pickup unit;
a second recognition unit configured to recognize a second situation of a second real space in accordance with a second video image obtained by capturing the second real space including the second terminal in advance by a second image pickup unit;
a bidirectional determination unit configured to determine whether a first display unit included in the first terminal and a second display unit included in the second terminal are allowed to display the second real space and the first real space, respectively, in a bidirectional manner; and
a control unit configured to perform control so that the first and second terminals transmit video images to each other in a bidirectional manner when the determination of the bidirectional determination unit is affirmative.

2. The video image information processing apparatus according to claim 1, further comprising:
a first generation unit configured to generate a first display video image to be displayed in the first display unit in accordance with a result of the determination performed by the bidirectional determination unit and the second video image when a video image is supplied from the second terminal; and
a second generation unit configured to generate a second display video image to be displayed in the second display unit in accordance with a result of the determination performed by the bidirectional determination unit and the first video image when a video image is supplied from the first terminal.

3. The video image information processing apparatus according to claim 1,
wherein the bidirectional determination unit includes
a first determination unit configured to determine whether the first real space is to be displayed in the second terminal,
a second determination unit configured to determine whether the second real space is to be displayed in the first terminal, and
a comparison unit configured to compare a result of the determination performed by the first determination unit and a result of the determination performed by the second determination unit so as to determine whether the first display unit included in the first terminal and the second display unit included in the second terminal are allowed to display the second real space and the first real space, respectively, in a bidirectional manner.

4. The video image information processing apparatus according to claim 3, wherein
the first determination unit determines a first display level representing a level of display of the first situation in the second terminal,
the second determination unit determines a second display level representing a level of display of the second situation in the first terminal, the first generation unit generates a first display video image to be displayed in the first terminal in accordance with a result of the determination performed by the bidirectional determination unit, the second display level, and the second video image, and
the second generation unit generates a second display video image to be displayed in the second terminal in accordance with a result of the determination performed by the bidirectional determination unit, the first display level, and the first video image.

5. The video image information processing apparatus according to claim 4, further comprising:
a first level data storage unit configured to store information on a first relationship between situations recognized by the first recognition unit and the first display level; and
a second level data storage unit configured to store information on a second relationship between situations recognized by the second recognition unit and the second display level.

6. The video image information processing apparatus according to claim 5, wherein
the first determination unit determines the first display level obtained by associating the first situation with the information on the first relationship in accordance with the first situation,
the second determination unit determines the second display level obtained by associating the second situation with the information on the second relationship in accordance with the second situation, and
the comparison unit determines that each of the first and second display units are not allowed to display the second situation of the second real space or the first situation of the first real space for the other of the first and second display units until a predetermined combination of the first and second display levels is obtained.

7. The video image information processing apparatus according to claim 6, wherein
when a predetermined period of time has been elapsed by the time
when the predetermined combination is obtained,
a first recording unit deletes the first situation, and
a second recording unit deletes the second situation.

8. The video image information processing apparatus according to claim 5, further comprising:
a data input unit configured to input the information on the first relationship and the information on the second relationship.

9. A video image information processing apparatus which controls a video image transmitted between first and second terminals in a bidirectional manner, the video image information processing apparatus comprising:
a bidirectional determination unit configured to determine whether a first display unit included in the first terminal and a second display unit included in the second terminal are allowed to display the second real space and the first real space, respectively, in a bidirectional manner in accordance with a first situation of a first real space recognized by a first recognition unit on the basis of a first video image obtained by capturing the first real space including, the first terminal in advance by a first image pickup unit and a second situation of a second real space recognized by a second recognition unit on the basis of a second video image obtained by capturing the second real space including the second terminal which is different from the first terminal in advance by a second image pickup unit; and
a control unit configured to perform control so that the first and second terminals transmit video images to each other in a bidirectional manner when the determination of the bidirectional determination unit is affirmative.

10. A video image information processing method for controlling a video image transmitted between first and second terminals in a bidirectional manner, the video image information processing method comprising:
a first recognition step of recognizing a first situation of a first real space in accordance with a first video image obtained by capturing the first real space including the first terminal in advance by a first image pickup unit;
a second recognition step of recognizing a second situation of a second real space in accordance with a second video image obtained by capturing the second real space including the second terminal in advance by a second image pickup unit;
a bidirectional determination step of determining whether a first display unit included in the first terminal and a second display unit included in the second terminal are allowed to display the second real space and the first real space, respectively, in a bidirectional manner; and
a control step of performing control so that the first and second terminals transmit video images to each other in a bidirectional manner when the determination of the bidirectional determination unit is affirmative.

11. A video image information processing method for controlling a video image transmitted between first and second terminals in a bidirectional manner, the video image information processing method comprising:
a bidirectional determination step of determining whether a first display unit included in the first terminal and a second display unit included in the second terminal are allowed to display the second real space and the first real space, respectively, in a bidirectional manner in accordance with a first situation of a first real space recognized by a first recognition unit on the basis of a first video image obtained by capturing the first real space including the first terminal in advance by a first image pickup unit and a second situation of a second real space recognized by a second recognition unit on the basis of a second video image obtained by capturing the second real space including the second terminal which is different from the first terminal in advance by a second image pickup unit; and
a control step of performing control so that the first and second terminals transmit video images to each other in a bidirectional manner when the determination of the bidirectional determination unit is affirmative.

12. A non-transitory storage medium which stores a program which causes a computer to execute the steps of the video image information processing method according to claim 10.

13. A non-transitory storage medium which stores a program which causes a computer to execute the steps of the video image information processing method according to claim 11.
